(19) United States
(12) Patent Application Publication
(10) Pub. No.: US 2010/0215921 A1
(43) Pub. Date: Aug. 26, 2010

(54) PHOTOCURABLE INK COMPOSITION, INK JET RECORDING METHOD, RECORDED MATTER, INK SET, INK CARTRIDGE, AND RECORDING APPARATUS

(75) Inventor: Taketoshi KAGOSE, Shiojiri-shi (JP)

Correspondence Address: LADAS & PARRY, 26 West 61st Street, New York, NY, 10023, US

(73) Assignee: SEIKO EPSON CORPORATION

(21) Appl. No.: 12/710,479

(22) Filed: Feb. 23, 2010

(30) Foreign Application Priority Data
Feb. 26, 2009 (JP) 2009-044106

(51) Int. Cl. B32B 3/10; C08F 2/46; B05D 5/00; B41J 2/175

(52) U.S. Cl. 428/195.1; 522/81; 427/256; 347/86

(57) ABSTRACT

A photocurable ink composition contains a polymerizable compound, a photopolymerization initiator, titanium oxide functioning as a pigment, and a dispersion resin having an amine value in the range of 8 to 15 in an amount in the range of 5% to 20% by mass relative to the pigment.

### BACKGROUND

1. Technical Field

The present invention relates to an ink composition that is cured by light such as ultraviolet light, and in particular, to a photocurable ink composition that exhibits a good ink-repellent property and storage stability. The invention also relates to an ink jet recording method and a recorded matter using the photocurable ink composition. Furthermore, the invention relates to an ink set, an ink cartridge, and a recording apparatus that are provided with the photocurable ink composition.

2. Related Art

An ink jet recording method is a printing method for performing printing by ejecting small droplets of an ink composition to allow the droplets to adhere to a recording medium such as paper. This ink jet recording method is characterized in that an image having a high resolution and high quality can be printed at a high speed. A typical ink composition used in the ink jet recording method contains an aqueous solvent as a main component, a coloring component, and a humectant, such as glycerin, which is added for the purpose of preventing clogging. On the other hand, when printing is performed on a recording medium composed of paper or a cloth through which an aqueous ink composition does not tend to penetrate or a material such as a metal or a plastic through which an aqueous ink composition does not penetrate, for example, a plate or film manufactured from a resin such as a phenolic resin, a melamine resin, polyvinyl chloride, an acrylic resin, polycarbonate, polyethylene terephthalate (PET), polypropylene (PP), or polyethylene (PE), it is desired that the ink composition contain a component that enables a colorant to stably adhere to the recording medium.

To meet the above desire, a photocurable ink-jet ink containing a colorant, a photo-curing agent, a polymerization initiator, and the like has been disclosed (refer to, for example, U.S. Pat. No. 5,623,001). According to this ink, bleeding of the ink on a recording medium can be prevented to improve the image quality.

In general, an ink jet recording apparatus that performs ink jet recording includes an ink ejection head configured to eject ink onto a recording medium, and the ink ejection head includes a nozzle plate in which nozzle openings are formed. A plurality of very small nozzles (ink ejection ports) for ejecting ink are provided through the nozzle plate at very small intervals. In such a typical ink jet recording apparatus, a nozzle opening surface of the nozzle plate and the surfaces of the inner walls of the nozzles are subjected to a liquid-repellent treatment for preventing adhesion of ink. The reason for this is as follows. If the ink adheres to the nozzle opening surface of the nozzle plate and the surfaces of the inner walls of the nozzles, the ejection path of an ink droplet ejected thereafter is bent by the influences of the surface tension, the viscosity, and the like of the adhered ink, and thus it is difficult to apply an ink droplet to a desired position on a recording medium.

Examples of known liquid-repellent treatments includes (i) a method of forming a metal oxide film and (ii) a method of forming a metal oxide film having a fluorine-containing hydrocarbon group at an end thereof, as a liquid-repellent film on the nozzle opening surface of a nozzle plate and the surfaces of the inner walls of the nozzles. A siloxane monomolecular film or the like is preferably used as the metal oxide film. Since a nozzle plate is made of a metal or glass, a plurality of hydroxyl groups (—OH groups) are present on the surface thereof. A liquid-repellent film (siloxane monomolecular film) having a high adhesiveness can be easily formed on the nozzle plate by allowing such hydroxyl groups to react with an alkoxysilane or the like.

JP-A-2004-351923 discloses a nozzle plate in which an underlying film is provided between a substrate and a liquid-repellent (water-repellent and oil-repellent) film composed of a metal alkoxide (e.g., alkoxysilane) or the like in order to further improve the adhesiveness between the substrate and the liquid-repellent film. This underlying film has a significantly large number of hydroxyl groups on the surface thereof, as compared with the substrate. Accordingly, as compared with the case where a metal oxide film such as a siloxane film is formed directly on the substrate, the substrate can be strongly bonded to the metal oxide film. JP-A-2004-351923 also describes that when the metal alkoxide contains a fluorine-containing long-chain polymer group, the fluorine-containing long-chain polymer groups are intertwined with each other, thereby further improving a liquid-repellent property.

Furthermore, JP-A-7-125219 discloses a method of forming, as a water-repellent film, a siloxane film having a fluorine-containing long-chain polymer group only on the nozzle opening surface of a nozzle plate. Thus, ejection of ink droplets of aqueous ink can be constantly stabilized to form a high-quality recorded image.

However, the inventor of the invention has found that, regarding some photocurable ink compositions, a sufficient ink-repellent property cannot be achieved even when the photocurable ink compositions are used for a nozzle plate provided with a liquid-repellent film having a fluorine-containing long-chain polymer group. This phenomenon is significantly observed in photocurable ink compositions containing titanium oxide as a pigment regardless of the liquid property of ink (aqueous ink, oil-based ink, or solvent ink). As a result, rectilinear flight of the ink is impaired during ink ejection, resulting in a problem that the ink cannot adhere to a desired position on a recording medium. This problem does not occur in photocurable ink compositions containing organic pigments. On the other hand, in general, in an ink composition in which a pigment is dispersed, dispersion stability (storage stability) of the pigment is important. When such an ink composition has poor storage stability, a problem such as unsatisfactory ink ejection may occur.

### SUMMARY

An advantage of some aspects of the invention is that it provides a photocurable ink composition that can achieve both good storage stability and a good ink-repellent property even when used for a nozzle plate provided with a liquid-repellent film having a fluorine-containing long-chain polymer group while the photocurable ink composition contains titanium oxide as a pigment. Another advantage of some aspects of the invention is that it provides an ink jet recording method and a recorded matter using the photocurable ink composition, and an ink set, an ink cartridge, and a recording apparatus that are provided with the photocurable ink composition.

As a result of intensive studies, the inventor of the invention found that, both an improvement in an ink-repellent property for a nozzle plate provided with a liquid-repellent film having a fluorine-containing long-chain polymer group and good storage stability can be achieved by incorporating a dispersion resin having an amine value in the range of 8 to 15 in a photocurable ink composition containing titanium oxide as a pigment in an amount in the range of 5% to 20% by mass relative to the pigment, and this finding led to the realization of the invention.

Specifically, a photocurable ink composition according to a first aspect of the invention contains a polymerizable compound, a photopolymerization initiator, titanium oxide functioning as a pigment, and a dispersion resin having an amine value in the range of 8 to 15 in an amount in the range of 5% to 20% by mass relative to the pigment.

In this case, the dispersion resin is preferably a polyurethane resin, a polyester resin, an ether resin, or an acrylic copolymer resin. The polymerizable compound preferably contains at least allyl glycol. The photocurable ink composition is preferably used in an ink jet application.

An ink jet recording method according to a second aspect of the invention includes forming an image using the photocurable ink composition according to the first aspect of the invention.

A recorded matter according to a third aspect of the invention includes a recording medium on which an image is formed by the ink jet recording method according to the second aspect of the invention.

An ink set according to a fourth aspect of the invention includes a plurality of photocurable ink compositions, wherein the ink set includes at least the photocurable ink composition according to the first aspect of the invention.

An ink cartridge according to a fifth aspect of the invention includes the ink set according to the fourth aspect of the invention.

A recording apparatus according to a sixth aspect of the invention includes the ink cartridge according to the fifth aspect of the invention. In this case, preferably, the recording apparatus is an ink jet recording apparatus including an ink ejection head, the ink ejection head includes a nozzle plate, and the nozzle plate has a liquid-repellent layer composed of a metal oxide film having a fluorine-containing long-chain polymer group on at least one region of a nozzle opening surface and/or at least one region of surfaces of the inner walls of nozzles.

### DESCRIPTION OF EXEMPLARY EMBODIMENTS

A photocurable ink composition according to an embodiment of the invention will now be described in detail. A photocurable ink composition of this embodiment contains a polymerizable compound, a photopolymerization initiator, titanium oxide serving as a pigment, and a dispersion resin having an amine value in the range of 8 to 15 in an amount in the range of 5% to 20% by mass relative to the pigment.

The photocurable ink composition of this embodiment contains a dispersion resin having an amine value in the range of 8 to 15. Herein, the term “amine value” is defined as the number of milligrams of potassium hydroxide equivalent to perchloric acid required for neutralizing all basic nitrogen atoms contained in 1 g of a dispersion resin. In general, the amine value can be determined in accordance with JIS K7237 by dissolving a sample in an o-nitrotoluene-glacial acetic acid solution and titrating the resulting solution with 0.1 N perchloric acid using Crystal Violet as an indicator. If the amine value of the dispersion resin is less than 8, dispersion stability of the ink composition decreases, thereby decreasing storage stability. On the other hand, if the amine value exceeds 15, the photocurable ink composition does not exhibit a sufficient ink-repellent property for a nozzle plate provided with a liquid-repellent film having a fluorine-containing long-chain polymer group.

Furthermore, the photocurable ink composition contains a dispersion resin having an amine value in the range of 8 to 15 in an amount in the range of 5% to 20% by mass relative to a pigment. If the amount of dispersion resin is less than 5% by mass, a sufficient ink-repellent property cannot be achieved for a nozzle plate provided with a liquid-repellent film having a fluorine-containing long-chain polymer group. On the other hand, if the amount of dispersion resin exceeds 20% by mass, storage stability decreases, though a good ink-repellent property is achieved.

In general, since the surface of a water-repellent plate such as a nozzle plate is coated with a fluorocarbon resin, the surface is slightly negatively charged. In ink mainly containing a solvent having a low polarity, titanium oxide is negatively charged. Therefore, although the ink exhibits an ink-repellent property, pigment particles are aggregated to each other because of a strong hydrophilic property of the ink, and thus dispersion stability cannot be obtained. In this embodiment, titanium oxide particles are coated with a dispersion resin, thus preventing the resulting ink from adhering to a plate while ensuring dispersion stability of the pigment by the steric interference. When the positive charge of the dispersion resin is large (when the amine value of the dispersion resin is high) to some extent, an electrical adsorption force exceeds the effect of the steric interference, and the ink is consequently adsorbed to the plate. On the other hand, when the dispersion resin is negatively charged (when the amine value of the dispersion resin is low), the dispersion resin does not sufficiently adsorb to the titanium oxide particles because of the repellence of the dispersion resin to the titanium oxide particles, and thus dispersion stability cannot be obtained. In this embodiment, both dispersion stability and the ink-repellent property can be achieved by incorporating a dispersion resin having an amine value in the range of 8 to 15 in an amount in the range of 5% to 20% by mass relative to titanium oxide.

The dispersion resin used in this embodiment is preferably a polyurethane resin, a polyester resin, an ether resin, or an acrylic copolymer resin in view of the dispersion stability of a pigment. Examples of the dispersion resin having an amine value in the range of 8 to 15 include EFKA 4015, 4020, 4046, and 4330 (trade names, available from Ciba Specialty Chemicals) and DISPERBYK-112, 168, 182, 184, and 112 (trade names, available from BYK Japan K.K.).

The photocurable ink composition of this embodiment preferably contains a dendritic polymer as a polymerizable compound. Dendritic polymers are broadly classified into the following six structures (refer to, “Dendritic polymers—The world of higher functionality achievement opened up by highly branched structures—” (Dendoritikku kobunshi—Tabunki kouzou ga hirogeru koukinouka no sekai—), edited by Keigo Aoi and Masaaki Kakimoto, published by NTS K.K.): The structures are dendrimers I, linear dendritic polymers II, dendrigraft polymers III, hyperbranched polymers IV, star-hyperbranched polymers V, and hypergraft polymers VI.

Among these dendritic polymers, the dendrimers I, the linear dendritic polymers II, and the dendrigraft polymers III have a degree of branching (DB) of 1 and have structures without defects. In contrast, the hyperbranched polymer IV, the star-hyperbranched polymer V, and the hypergraft polymer VI have randomly branched structures that may have defects. In particular, since reactive functional groups can be arranged densely and intensively on the outermost surface of dendrimers as compared with generally-used linear polymers, dendrimers are highly expected to be functional polymer materials. It is also possible to introduce a large number of reactive functional groups into the outermost surface of hyperbranched polymers, dendrigraft polymers, or hypergraft polymers, though not so many as dendrimers. Accordingly, these polymers exhibit good curability.

Unlike known linear or branched polymers, the dendritic polymers have three-dimensional highly branched repeating structures. Therefore, the dendritic polymers can be controlled to have lower viscosity as compared with linear polymers having substantially the same molecular weight as that of the dendritic polymers.

Examples of a method of synthesizing a dendrimer used in this embodiment include a divergent method in which synthesis proceeds outward from the center and a convergent method in which synthesis proceeds from the outside toward the center.

The dendrimer, hyperbranched polymer, dendrigraft polymer, or hypergraft polymer used in this embodiment is a solid at room temperature and preferably has a number-average molecular weight in the range of 1,000 to 100,000 and more preferably in the range of 2,000 to 50,000. If the dendritic polymer is not a solid at room temperature, an image formed from the polymer is not satisfactorily maintained. If the dendritic polymer has a molecular weight lower than the above range, a fixed image formed from the polymer is brittle. If the dendritic polymer has a molecular weight higher than the above range, ink containing the polymer is impractical in terms of the ejection property because the ink has excessively high viscosity even if the content of the dendritic polymer in the ink is reduced.

The dendrimer, hyperbranched polymer, dendrigraft polymer, or hypergraft polymer used in this embodiment preferably contains radically polymerizable functional groups arranged on the outermost surface thereof. The structure having radically polymerizable functional groups on the outermost surface allows a polymerization reaction to proceed rapidly.

Examples of polymers having a dendrimer structure include amide amine dendrimers (U.S. Pat. Nos. 4,507,466, 4,558,120, 4,568,737, 4,587,329, 4,631,337, and 4,694,064) and phenyl ether dendrimers (U.S. Pat. No. 5,041,516 and Journal of American Chemistry Vol. 112 (1990, pp. 7638-7647)). An amide amine dendrimer named “Starburst TM (PAMAM)” having a terminal amino group and a methyl carboxylate group is commercially available from Aldrich. Alternatively, the terminal amino group of the amide amine dendrimer may be allowed to react with an acrylic acid derivative or a methacrylic acid derivative to synthesize an amide amine dendrimer having terminals corresponding to the acrylic or methacrylic acid derivative, and the resulting amide amine dendrimer may be used.

Examples of the acrylic and methacrylic acid derivatives include, but are not limited to, alkyl (meth)acrylates, such as methyl(meth)acrylate, ethyl(meth)acrylate, n-butyl(meth)acrylate, t-butyl(meth)acrylate, cyclohexyl(meth)acrylate, palmityl(meth)acrylate, and stearyl(meth)acrylate; and (meth)acrylic acid alkylamides such as acrylic acid amide and (meth)acrylic acid isopropylamide.

For example, the above cited document, Journal of American Chemistry Vol. 112 (1990, pp. 7638-7647), describes various phenyl ether dendrimers. According to the document, for example, 3,5-dihydroxybenzyl alcohol is allowed to react with 3,5-diphenoxybenzyl bromide to synthesize a second-generation benzyl alcohol. The hydroxyl group (—OH group) of the benzyl alcohol is replaced with Br using CBr₄ and triphenylphosphine, and the resulting product is then allowed to react with 3,5-dihydroxybenzyl alcohol to synthesize a next-generation benzyl alcohol. The same reaction is repeated to synthesize a desired dendrimer. The terminal benzyl ether bonds of phenyl ether dendrimers may also be replaced with various chemical structures. For example, in the synthesis of a dendrimer described in the above document, Journal of American Chemistry Vol. 112, an alkyl halide may be used instead of the benzyl bromide to produce a phenyl ether dendrimer having a terminal structure including the corresponding alkyl group. Alternatively, polyamine dendrimers (Macromol. Symp. 77, 21 (1994)) and derivatives thereof, the terminal groups of which have been modified, can also be used.

For example, hyperbranched polyethylene glycol can be used as a hyperbranched polymer. Hyperbranched polymers are produced by synthesizing a target polymer in a single step using a monomer having, per molecule, two or more reaction points of one type acting as branch portions and only one reaction point of another type acting as a binding portion (Macromolecules, Vol. 29 (1996), pp. 3831-3838). Examples of the monomer for synthesizing such a hyperbranched polymer include 3,5-dihydroxybenzoic acid derivatives. A hyperbranched polymer can be produced by, for example, heating methyl 3,5-bis((8′-hydroxy-3′,6′-dioxaoctyl)oxy)benzoate, which is a hydrolysate of methyl 3,5-bis((8′-(t-butyldiphenylsiloxy)-3′,6′-dioxaoctyl)oxy)benzoate produced from 1-bromo-8-(t-butyldiphenylsiloxy)-3,6-dioxaoctane and methyl 3,5-dihydroxybenzoate, with dibutyltin diacetate in a nitrogen atmosphere. Thus, poly[bis(triethylene glycol)benzoate], which is a hyperbranched polymer, can be synthesized.

When 3,5-dihydroxybenzoic acid is used, the terminal group of the resulting hyperbranched polymer is a hydroxyl group. By allowing an appropriate alkyl halide to react with the hydroxyl group, hyperbranched polymers having a variety of terminal groups can be synthesized.

The characteristics of monodisperse polymers having dendrimer structures, hyperbranched polymers, or the like depend on the chemical structures of the main chain and the terminal group thereof, and, in particular, are significantly varied depending on the differences in the terminal group and the substituents in the chemical structure. In particular, a structure having a polymerizable group at the end is useful because such a structure exhibits a high effect of gelation after a photoreaction owing to the reactivity thereof. A dendrimer having a polymerizable group can be produced by chemically modifying the end of a structure having a basic atomic group, such as an amino group, a substituted amino group, or a hydroxyl group, at the end thereof with a compound having a polymerizable group.

Specifically, for example, a polyfunctional compound produced by Michael addition of an active hydrogen-containing (meth)acrylate compound to an amino dendrimer is subjected to an addition reaction with, for example, an isocyanate group-containing vinyl compound. Alternatively, an amino dendrimer may be allowed to react with (meth)acrylic acid chloride or the like. Thus, a dendrimer having a polymerizable group at the end can be produced. Examples of the vinyl compound that provides such a polymerizable group are compounds having a radically polymerizable ethylenic unsaturated bond. Specific examples of the compounds having a radically polymerizable ethylenic unsaturated bond include unsaturated carboxylic acids, such as acrylic acid, methacrylic acid, itaconic acid, crotonic acid, isocrotonic acid, and maleic acid; and salts thereof.

In this embodiment, the above-described dendrimers, hyperbranched polymers, dendrigraft polymers, and hypergraft polymers may be used alone or in combination with a different type of dendrimer or hyperbranched polymer.

In the photocurable ink composition of this embodiment, the amount of dendritic polymer added is preferably 5% by mass or more, more preferably in the range of 10% to 30% by mass, and further preferably in the range of 10% to 20% by mass. When the amount is within the above range, the suitability as a photocurable ink can be preferably maintained. When the amount of dendritic polymer added is 5% by mass or more, satisfactory curability can be ensured. When the amount of dendritic polymer added is 30% by mass or less, problems in terms of the viscosity, dispersion stability, and storage stability, and the like do not occur in the resulting ink composition.

The photocurable ink composition of this embodiment preferably contains allyl glycol as a polymerizable compound. The content of allyl glycol in the photocurable ink composition is in the range of 20% to 80% by mass, preferably in the range of 50% to 80% by mass, more preferably in the range of 50% to 75% by mass, and most preferably in the range of 60% to 75% by mass relative to the total amount of ink composition. If the amount of allyl glycol added is less than 20% by mass, problems in terms of the viscosity, dispersion stability, and storage stability, and the like may occur in the resulting ink composition. If the amount of allyl glycol added exceeds 80% by mass, the photocurable ink composition may have insufficient curability.

The photocurable ink composition may further contain a polymerizable compound other than the above-mentioned compounds. An example of such a polymerizable compound is a monomer but is not particularly limited thereto. The monomer refers to a molecule that can be a constitutional unit of the basic structure of a polymer. Examples of the monomers used in this embodiment include monofunctional monomers, bifunctional monomers, and polyfunctional monomers. Any of the monomers preferably has a primary irritation index (PII) of 2 or less.

Table 1 shows examples of usable monofunctional, bifunctional, and polyfunctional monomers having a PII of 2 or less.

TABLE 1

| | | |
|---|---|---|
| | Viscosity | |
| Compound | (mPa · s) | P.I.I |

Monofunctional monomers

| | | |
|---|---|---|
| (2-Methyl-2-ethyl-1,3-dioxolane-4-yl)methyl acrylate | 5.1 | 1.3 |
| (MEDOL-10, Osaka Organic Chemical Industry Ltd.) | | |
| (2-Methyl-2-isobutyl-1,3-dioxolane-4-yl)methyl | 5.3 | 1.0 |
| acrylate (MIBDOL-10, Osaka Organic Chemical | | |
| Industry Ltd.) | | |
| Phenoxyethyl acrylate (Biscoat #192, Osaka Organic | 3.3 | 1.7 |
| Chemical Industry Ltd.) | | |
| Isobornyl acrylate (IBXA, Osaka Organic Chemical | 2.6 | 0.6 |
| Industry Ltd.) | | |
| Methoxy diethylene glycol monoacrylate | 2 | 0.7 |
| (BLEMMER PME-100, NOF Corporation) | | |
| Acryloyl morpholine (ACMO, Kohjin Co., Ltd.) | 12 | 0.5 |

Bifunctional monomers

| | | |
|---|---|---|
| Ethylene glycol dimethacrylate (Light-Ester EG, | 3 | 0.6 |
| Kyoeisha Chemical Co., Ltd.) | | |
| Diethylene glycol dimethacrylate (Light-Ester 2EG, | 5 | 0.5 |
| Kyoeisha Chemical Co., Ltd.) | | |
| Tripropylene glycol diacrylate (Aronix M-220, | 12 | 1.6 |
| Toagosei Co., Ltd.) | | |
| 1,9-Nonanediol diacrylate (Biscoat #260, Osaka | 21 | 2.0 |
| Organic Chemical Industry Ltd.) | | |
| Polyethylene glycol #400 diacrylate (NK Ester A400, | 58 | 0.4 |
| Shin-Nakamura Chemical Co., Ltd.) | | |
| Tetraethylene glycol dimethacrylate (NK Ester 4G, | 14 | 0.5 |
| Shin-Nakamura Chemical Co., Ltd.) | | |
| 1,6-Hexanediol dimethacrylate (NK Ester HD-N, Shin- | 6 | 0.5 |
| Nakamura Chemical Co., Ltd.) | | |
| Neopentyl glycol dimethacrylate (NK Ester NPG, | 7 | 0.0 |
| Shin-Nakamura Chemical Co., Ltd.) | | |
| 2-Hydroxy-1,3-dimethacryloxypropane (NK Ester | 37 | 0.6 |
| 701, Shin-Nakamura Chemical Co., Ltd.) | | |

Polyfunctional monomers

| | | |
|---|---|---|
| Trimethylolpropane trimethacrylate (NK Ester TMPT, | 42 | 0.8 |
| Shin-Nakamura Chemical Co., Ltd.) | | |
| Trimethylolpropane-modified triacrylate (Biscoat | 55 | 1.5 |
| #360, Osaka Organic Chemical Industry Ltd.) | | |
| Trimethylolpropane PO-modified triacrylate (NEW | 60 | 0.1 |
| FRONTIER TMP-3P, Dai-ichi Kogyo Seiyaku Co., | | |
| Ltd.) | | |
| Glycerin PO-modified triacrylate (Biscoat #GPT, | 75 | 0.8 |
| Osaka Organic Chemical Industry Ltd.) | | |

The viscosities shown in Table 1 are values measured at 25° C.

The photocurable ink composition may contain an N-vinyl compound as another monofunctional monomer or polyfunctional monomer. Examples of the N-vinyl compound include N-vinylformamide, N-vinylcarbazole, N-vinylacetamide, N-vinylpyrrolidone, N-vinylcaprolactam, acryloylmorpholine, and derivatives thereof. In particular, N-vinylformamide is preferable because it exhibits good curability. Urethane monomers are also preferably used. The photocurable ink composition may further contain an oligomer as a polymerizable compound in addition to the above-mentioned monomer.

The photocurable ink composition of this embodiment contains a photopolymerization initiator. The initiator is preferably a photo-radical polymerization initiator. Examples of the photo-radical polymerization initiator include, but are not particularly limited to, benzyl dimethyl ketal, α-hydroxyalkylphenone, α-aminoalkylphenone, acylphosphine oxide, oxime esters, thioxanthone, α-dicarbonyl, and anthraquinone.

Examples of the photopolymerization initiators also include photopolymerization initiators that are available under the trade names of Vicure 10 and 30 (produced by Stauffer Chemical Company), Irgacure 127, 184, 500, 651, 2959, 907, 369, 379, 754, 1700, 1800, 1850, 1870, 819, OXE01, Darocur 1173, TPO, and ITX (produced by Ciba Specialty Chemicals), Quantacure CTX (produced by Aceto Chemical Company), Kayacure DETX-S (produced by Nippon Kayaku Co., Ltd.), and ESACURE KIP150 (produced by Lamberti). In the photocurable ink composition, the amount of initiator added is, for example, in the range of 1% to 20% by mass, and preferably, in the range of 3% to 15% by mass.

The photocurable ink composition of this embodiment may contain a polymerization accelerator. Examples of the polymerization accelerator include, but are not particularly limited to, Darocur EHA and EDB (produced by Ciba Specialty Chemicals). The photocurable ink composition of this embodiment preferably contains a thermal radical polymerization inhibitor. Accordingly, the storage stability of the ink composition is improved. Examples of the thermal radical polymerization inhibitor include Irgastab UV-10 and UV-22 (produced by Ciba Specialty Chemicals).

Furthermore, the photocurable ink composition of this embodiment may contain a surfactant. For example, a polyester-modified silicone or a polyether-modified silicone is preferably used as a silicone surfactant. A polyether-modified polydimethylsiloxane or a polyester-modified polydimethylsiloxane is particularly preferably used. Specific examples thereof include BYK-347, BYK-348, BYK-UV3510, 3530, and 3570 (produced by BYK Japan K.K.).

The photocurable ink composition of this embodiment contains, as a pigment, titanium oxide which is a white pigment. The titanium oxide is not particularly limited. However, from the standpoint of a covering property of the white pigment, the titanium oxide preferably has an average particle size in the range of 180 to 300 nm in terms of the cumulative average size, and the content of titanium oxide in the ink composition is preferably in the range of 6% to 10% by mass.

Besides the above components, a leveling additive; a matting agent; and a polyester resin, a polyurethane resin, a vinyl resin, an acrylic resin, a rubber resin, or wax for adjusting physical properties of a film may be optionally added to the photocurable ink composition.

According to this embodiment, the above pigment can be contained in the photocurable ink composition in the form of a pigment dispersion liquid prepared by dispersing the pigment in a medium with a dispersing agent or a surfactant.

The photocurable ink composition of this embodiment may be either a one-liquid-type or two-liquid-type ink composition.

The photocurable ink composition of this embodiment is irradiated with light to perform a curing reaction. The irradiation light source is not particularly limited. However, the irradiation light source is preferably light having a wavelength of 350 nm or more and 450 nm or less and light having an emission peak in the range of 360 to 410 nm. The active ray used for curing the photocurable ink composition is not particularly limited but is preferably ultraviolet light. When ultraviolet light is used, the exposure dose is set in the range of 10 mJ/cm² or more and 10,000 mJ/cm² or less, and preferably 50 mJ/cm² or more and 6,000 mJ/cm² or less. An exposure dose (illumination intensity) of ultraviolet light within the above ranges ensures a sufficient curing reaction.

Examples of the light source used for the ultraviolet light irradiation include lamps such as a metal halide lamp, a xenon lamp, a carbon arc lamp, a chemical lamp, a low-pressure mercury lamp, and a high-pressure mercury lamp. For example, commercially available lamps such as H Lamp, D Lamp, and V Lamp produced by Fusion System can be used. Alternatively, an ultraviolet light-emitting semiconductor element, such as an ultraviolet light-emitting diode (ultraviolet light LED) or an ultraviolet light-emitting semiconductor laser may be used for the ultraviolet light irradiation.

The photocurable ink composition according to this embodiment exhibits a good ink-repellent property even when used for a nozzle plate provided with a liquid-repellent film having a fluorine-containing long-chain polymer group and has good storage stability, though the photocurable ink composition contains titanium oxide as a pigment.

An embodiment of the invention also provides an ink jet recording method in which an image is formed on a recording medium using the above-described photocurable ink composition. Any typical known ink jet recording method can be used. In particular, excellent image recording can be realized in a method of ejecting a liquid droplet using vibration of a piezoelectric element (recording method using an ink jet head in which an ink droplet is formed by mechanical deformation of an electrostrictive element) and a method using thermal energy. According to the ink jet recoding method of this embodiment, the above-described photocurable ink composition is used. Therefore, even when the ink jet recoding method is applied to a nozzle plate provided with a liquid-repellent film having a fluorine-containing long-chain polymer group, ink can be applied to a desired position on a recording medium without impairing rectilinear flight of the ink during ink ejection. Accordingly, the ink jet recording method of this embodiment can provide a recorded matter in which a high-quality white image is formed on a recording medium.

In addition, an embodiment of the invention can provide an ink set including a plurality of photocurable ink compositions wherein the ink set includes at least the above-described photocurable ink composition. Since the photocurable ink composition of this embodiment contains titanium oxide as a pigment, the ink composition exhibits white. As for the ink set, in addition to ink compositions for four fundamental colors, i.e., yellow, magenta, cyan, and black, a plurality of ink compositions may be prepared for each of these colors. Specifically, when deep and light colors are used in addition to each of the four fundamental colors, i.e., yellow, magenta, cyan, and black, for example, light magenta and deep red may be used in addition to magenta; light cyan and deep blue may be used in addition to cyan; gray, light black, and dark matte black may be used in addition to black.

Each of the colorants used for yellow, magenta, cyan, and black may be a dye or a pigment, and pigments are advantageous from the viewpoint of enhancing the durability of printed matters. Examples of dyes that can be used in this embodiment include various types of dye generally used for ink jet recording, such as direct dyes, acid dyes, food dyes, basic dyes, reactive dyes, disperse dyes, vat dyes, soluble vat dyes, and reactive disperse dyes.

As for each of pigments of yellow, magenta, cyan, and black, inorganic pigments and organic pigments can be used without particular limitation. Examples of the inorganic pigments include iron oxide and carbon black manufactured by a known method such as the contact method, the furnace method, or the thermal method. Examples of the organic pigments include azo pigments such as azo lake, insoluble azo pigments, condensed azo pigments, and chelate azo pigments; polycyclic pigments such as phthalocyanine pigments, perylene pigments, perinone pigments, anthraquinone pigments, quinacridone pigments, dioxazine pigments, thioindigo pigments, isoindolinone pigments, and quinofuralone pigments; dye chelates such as basic dye chelates and acid dye chelates; nitro pigments; nitroso pigments; and aniline black.

Specific examples of the pigments will be described. Examples of carbon black include No. 2300, No. 900, MCF88, No. 33, No. 40, No. 45, No. 52, MA7, MA8, MA100, and No. 2200B produced by Mitsubishi Chemical Corporation; Raven 5750, Raven 5250, Raven 5000, Raven 3500, Raven 1255, and Raven 700 produced by Columbian Chemicals Company; Regal 400R, Regal 330R, Regal 660R, Mogul L, Mogul 700, Monarch 800, Monarch 880, Monarch 900, Monarch 1000, Monarch 1100, Monarch 1300, and Monarch 1400 produced by Cabot Corporation; and Color Black FW1, Color Black FW2, Color Black FW2V, Color Black FW18, Color Black FW200, Color Black S150, Color Black 5160, Color Black 5170, Printex 35, Printex U, Printex V, Printex 140U, Special Black 6, Special Black 5, Special Black 4A, and Special Black 4 produced by Degussa.

Examples of the pigments used for yellow ink include C. I. Pigment Yellows 1, 2, 3, 12, 13, 14, 16, 17, 73, 74, 75, 83, 93, 95, 97, 98, 109, 110, 114, 120, 128, 129, 138, 150, 151, 154, 155, 180, 185, and 213. Examples of pigments used for magenta ink include C. I. Pigment Reds 5, 7, 12, 48 (Ca), 48 (Mn), 57 (Ca), 57:1, 112, 122, 123, 168, 184, 202, and 209, and C. I. Pigment Violet 19.

Examples of the pigments used for cyan ink include C. I. Pigment Blues 1, 2, 3, 15:3, 15:4, 60, 16, and 22. Each of these pigments preferably has an average particle size in the range of 10 to 200 nm, and more preferably in the range of about 50 to 150 nm. The amount of colorant added in the photocurable ink composition is preferably in the range of about 0.1% to 25% by mass, and more preferably in the range of about 0.5% to 15% by mass.

The ink set of this embodiment includes the above-described photocurable ink composition. Accordingly, the ink set exhibits a good ink-repellent property even when used for a nozzle plate provided with a liquid-repellent film having a fluorine-containing long-chain polymer group, and has good storage stability, though the ink set contains titanium oxide as a pigment.

An embodiment of the invention can also provide an ink cartridge including the above-described photocurable ink composition. Since the ink cartridge of this embodiment includes the photocurable ink composition, the ink cartridge exhibits a good ink-repellent property even when used for a nozzle plate provided with a liquid-repellent film having a fluorine-containing long-chain polymer group, and has good storage stability, though the ink cartridge contains titanium oxide as a pigment.

An embodiment of the invention can also provide a recording apparatus provided with the above-described ink cartridge. The recording apparatus of this embodiment includes an ink ejection head, and the ink ejection head preferably includes a nozzle plate provided with a liquid-repellent film having a fluorine-containing long-chain polymer group. It is sufficient that the liquid-repellent film is provided on at least one region of a nozzle opening surface and/or at least one region of surfaces of the inner walls of nozzles. According to this structure, ink can be applied to a desired position on a recording medium without impairing rectilinear flight of the ink during ink ejection. Accordingly, the recording apparatus of this embodiment can provide a recorded matter in which a high-quality white image is formed on a recording medium.

### EXAMPLES

The invention will now be described in detail by way of Examples. However, the invention is not limited thereto.

### Method of Producing Titanium Dioxide Fine Particles

Titanium-containing ore was dissolved in sulfuric acid to prepare a titanium sulfate solution. To hydrated titanium oxide obtained by hydrolysis of the titanium sulfate solution, 0.50 parts by mass of ammonium phosphate, 0.30 parts by mass of potassium sulfate, and 0.30 parts by mass of aluminum sulfate were added per 100 parts by mass of TiO₂, and the hydrated titanium oxide was heated in a laboratory rotary muffle furnace until the product temperature reached 1,020° C. Titanium dioxide fine particles thus prepared were cooled to room temperature, and observed by transmission electron micrograph. The particles had the anatase structure and an average primary particle diameter of 0.30 μm.

### Preparation of Pigment Dispersion Liquid

Pigment dispersion liquids were each prepared on the basis of the basic composition shown in Table 2. The above surface-treated titanium dioxide fine particles used as a white pigment, the dispersion resin shown in Table 4, and allyl glycol were mixed to obtain a slurry, and the slurry was dispersed for two hours in a sand mill (produced by Yasukawa Seisakusho) in which zirconium beads (having a diameter of 1.0 mm) were charged in an amount 1.5 times the slurry. The beads were then removed from the slurry to obtain a 40 wt % pigment dispersion liquid of the titanium dioxide fine particles (C.I. Pigment White 6).

### Preparation of Photocurable Ink Composition

Photocurable ink compositions shown in Table 4 were each prepared on the basis of the basic composition shown in Table 3. First, the polymerizable compounds, the photopolymerization initiators, the thermal polymerization inhibitor, the surfactant were mixed and completely dissolved to prepare an ink composition. Subsequently, the pigment dispersion liquid prepared above was gradually added dropwise to the ink solvent of the ink composition while stirring. After completion of the dropwise addition, the resulting mixture was mixed and stirred at room temperature for one hour to obtain an ink composition. Subsequently, the ink composition was filtered with a 10-μm membrane filter. Thus, the photocurable ink compositions shown in Table 4 were prepared. The numerical values in the tables are represented in units of “% by mass”.

The compounds shown in Tables 3 and 4 are as follows:

STAR-501: dendritic polymer (hyperbranched polymer), produced by Osaka Organic Chemical Industry Ltd.

NK Oligo U-15HA: urethane acrylate, produced by Shin-Nakamura Chemical Co., Ltd.

Irgastab UV-10: polymerization inhibitor, produced by Ciba Specialty Chemicals

Irgacure 819: photopolymerization initiator (acylphosphine oxide), produced by Ciba Specialty Chemicals

Irgacure 127: photopolymerization initiator (alkylphenone), produced by Ciba Specialty Chemicals

BYK-UV3570, surfactant, produced by BYK Japan K.K.

DISPERBYK-2000: acrylic dispersion resin, produced by BYK Japan K.K.

EFKA 4020: polyurethane dispersion resin, produced by Ciba Specialty Chemicals

EFKA 4015: polyurethane dispersion resin, produced by Ciba Specialty Chemicals

DISPERBYK-168: polyester dispersion resin, produced by BYK Japan K.K.

DISPERBYK-182: ether dispersion resin, produced by BYK Japan K.K.

DISPERBYK-184: ether dispersion resin, produced by BYK Japan K.K.

EFKA 4046: polyurethane dispersion resin, produced by Ciba Specialty Chemicals

EFKA 4330: acrylic dispersion resin, produced by Ciba Specialty Chemicals

DISPERBYK-112: acrylic dispersion resin, produced by BYK Japan K.K.

### Evaluation of Ink-Repellent Property

Ink was dropped on a nozzle plate (nozzle plate to be mounted on PM-A890 produced by Seiko Epson Corporation) having a liquid repellent layer (liquid repellent film) having a fluorine-containing long-chain polymer group on the surface that contacts the ink, and the ink droplet was wiped with a butyl rubber wiper. The ink-repellent property was evaluated by visual observation in accordance with the standard below. Table 4 shows the results.

A: The ink did not remain on the nozzle plate after wiping had been performed 3,000 times.
B: The ink remained on the nozzle plate after wiping had been performed 3,000 times.

### Evaluation of Storage Stability

The storage stability was evaluated on the basis of the viscosity-increasing ratio of ink determined after the ink was left to stand at 60° C. for five days. The evaluation was performed in accordance with the standard below. Table 4 shows the results.

A: The viscosity-increasing ratio was less than 5%.
B: The viscosity-increasing ratio was 5% or more.

TABLE 2
Pigment dispersion liquid

| | | |
|---|---|---|
| Pigment | Pigment White 6 | 40 |
| Dispersion resin | Refer to Table 4 | 0 to 10 |
| Solvent | Allyl glycol | 50 to 60 |
| Total | | 100 |

TABLE 3
Basic composition

| | | |
|---|---|---|
| Polymerizable | STAR-501 | 3.33 |
| compound | Allyl glycol | 64.97 |
| | NK Oligo U-15HA | 5 |
| Thermal | Irgastab UV-10 | 0.2 |
| polymerization | | |
| inhibitor | | |
| Photopolymerization | Irgacure 819 | 4.8 |
| initiator | Irgacure 127 | 1.6 |
| Surfactant | BYK-3570 | 0.1 |
| Pigment dispersion | Refer to Table 2 | 20 |
| liquid | | |
| Total | | 100 |

TABLE 4

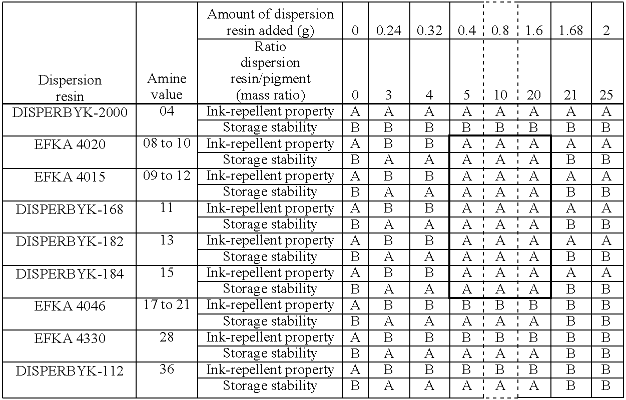

Referring to the results shown in Table 4, by incorporating a dispersion resin having an anime value in the range of 8 to 15 in a photocurable ink composition in an amount in the range of 5% to 20% by mass, both the ink-repellent property and the storage stability could be achieved at a high level, even when the photocurable ink composition was used for a nozzle plate provided with a liquid-repellent film having a fluorine-containing long-chain polymer group (refer to the area surrounded by the thick line in Table 4). Therefore, although such ink compositions contained titanium oxide as a pigment, ink could be applied to a desired position on a recording medium without impairing rectilinear flight of the ink during ink ejection in ink jet recording. Furthermore, since such photocurable ink compositions were excellent also in terms of storage stability, satisfactory ejection stability could be maintained for a long period of time. In contrast, photocurable ink compositions containing a dispersion resin having an amine value exceeding 15 had a poor ink-repellent property. Furthermore, even in the cases where a photocurable ink composition contained a dispersion resin having an amine value in the range of 8 to 15, the ink-repellent property was not improved when the content of the dispersion resin was less than 5% by mass relative to the pigment, whereas satisfactory storage stability could not be achieved when the content of the dispersion resin exceeded 20% by mass.

Next, for each of the photocurable ink compositions shown in the area surrounded by the dotted line in Table 4, the ink-repellent property to plates (1) to (3) below was evaluated. Plate (1) is the fluorocarbon resin-coated nozzle plate described in Example 1 of JP-A-7-125219. Plate (2) is the fluorocarbon resin-coated nozzle plate described in the embodiment of JP-A-2004-351923. Plate (3) is the nickel eutectoid-plated plate described in JP-A-4-74651.

TABLE 5

| | | Ratio of | | | |
|---|---|---|---|---|---|
| | | dispersion | Ink-repellent property | | |
| Dispersion | Amine | resin to | Plate | Plate | Plate |
| resin | value | pigment (%) | (1) | (2) | (3) |
| EFKA 4020 | 8 to 10 | 10 | A | A | B |
| EFKA 4015 | 9 to 12 | 10 | A | A | B |
| DISPERBYK-168 | 11 | 10 | A | A | B |
| DISPERBYK-182 | 13 | 10 | A | A | B |
| DISPERBYK-184 | 15 | 10 | A | A | B |
| EFKA 4046 | 17 to 21 | 10 | B | B | B |
| EFKA 4330 | 28 | 10 | B | B | B |
| DISPERBYK-112 | 36 | 10 | B | B | B |

Referring to the results shown in Table 5, the photocurable ink compositions according to embodiments of the invention had a good suitability to nozzle plates coated with a fluorocarbon resin.

1. A photocurable ink composition comprising:
a polymerizable compound;
a photopolymerization initiator;
titanium oxide functioning as a pigment; and
a dispersion resin having an amine value in the range of 8 to 15 in an amount in the range of 5% to 20% by mass relative to the pigment.

2. The photocurable ink composition according to claim 1, wherein the dispersion resin is a polyurethane resin, a polyester resin, an ether resin, or an acrylic copolymer resin.

3. The photocurable ink composition according to claim 1, wherein the polymerizable compound contains at least allyl glycol.

4. The photocurable ink composition according to claim 1, wherein the photocurable ink composition is used in an ink jet application.

5. An ink jet recording method comprising:
forming an image using the photocurable ink composition according to claim 1.

6. A recorded matter comprising:
a recording medium on which an image is formed by the ink jet recording method according to claim 5.

7. An ink set comprising:
a plurality of photocurable ink compositions,
wherein the ink set includes at least the photocurable ink composition according to claim 1.

8. An ink cartridge comprising:
the ink set according to claim 7.

9. A recording apparatus comprising:
the ink cartridge according to claim 8.

10. The recording apparatus according to claim 9,
wherein the recording apparatus is an ink jet recording apparatus including an ink ejection head,
the ink ejection head includes a nozzle plate, and
the nozzle plate has a liquid-repellent layer composed of a metal oxide film having a fluorine-containing long-chain polymer group on at least one region of a nozzle opening surface and/or at least one region of surfaces of the inner walls of nozzles.
